(19) United States
(12) Patent Application Publication
(10) Pub. No.: US 2015/0260985 A1
(43) Pub. Date: Sep. 17, 2015

(54) LASER PROCESSING APPARATUS AND LASER PROCESSING METHOD

(71) Applicant: Panasonic Intellectual Property Management Co., Ltd., Osaka (JP)

(72) Inventors: YOSHIRO KITAMURA, Osaka (JP); IZURU NAKAI, Osaka (JP)

(21) Appl. No.: 14/626,850

(22) Filed: Feb. 19, 2015

(30) Foreign Application Priority Data
Mar. 13, 2014 (JP) 2014-050470

(51) Int. Cl. G02B 26/10; G02B 27/09; G02B 5/30; G02B 27/28

(52) U.S. Cl. CPC G02B 26/106; G02B 26/101; G02B 26/105; G02B 26/10; G02B 27/286; G02B 27/0944; G02B 27/0927; G02B 5/3083

(57) ABSTRACT

In a laser processing apparatus and a laser processing method, a laser beam radiated from a laser oscillator is positioned on one minute diffraction pattern or over two or more minute diffraction patterns provided in a diffraction optical element by a moving unit. A laser beam to which a desired beam profile is given is reflected at an angle in which the laser beam is radiated to a target position on a processed object by a scanning unit, and the laser beam is transmitted through the lens unit a position in the Z-axis direction of which is controlled so that a focal point of the lens unit corresponds to the surface of the processed object. The processed object is irradiated with a laser beam converged by the lens unit and having a desired laser beam profile to realize desired processing.

### CROSS-REFERENCE TO RELATED APPLICATION

The present application claims the benefit of foreign priority of Japanese Patent Application No. 2014-050470 filed on Mar. 13, 2014, the contents of which are incorporated herein by reference.

### TECHNICAL FIELD

The technical field relates to a laser processing apparatus and a laser processing method capable of obtaining a desired laser beam profile.

### BACKGROUND

In the case of forming a pattern on glass, silicon or sapphire, or in the case of using laser for the bonding of metal or resin, there is a laser processing apparatus which performs processing, for example, by using a YAG laser oscillator, a fiber laser oscillator or the like as a laser beam source, modulating a laser beam emitted from the laser beam source by a diffraction optical element such as a diffraction grating and irradiating a sample with a desired laser beam profile.

As a related-art laser processing apparatus having a means for dividing a laser beam profile into a desired shape to form a profile, there is one in which diffraction optical elements are provided on a rotation disc (for example, refer to JP-A-2000-2000-280085 (Patent Document 1)). FIG. 8A and FIG. 8B are views showing a related-art laser processing apparatus described in Patent Document 1.

In FIG. 8A, the related-art laser processing apparatus includes a laser beam source 101, a light amount variable unit 102, a variable aperture 103, a light modulation apparatus 104, having a rotation disc D, a dichroic mirror 105, an objective lens 106 and so on. The laser beam source 101 is formed by a YAG laser having a Q-switch outputting a pulse-shaped laser beam by repetition. In FIG. 8B, for example, four diffraction optical elements 108a, 108b, 108c and 108d are provided on the rotation disc D.

A laser beam La emitted from the laser beam source 101 is transmitted through the light amount variable unit 102 and the variable aperture 103, being modulated by the diffraction optical elements 108a, 108b, 108c and 108d on the rotation disc D to be a laser beam Lb having a given diffraction pattern. The laser beam Lb abuts on the dichroic mirror 105 and is reflected downward to be incident on the objective lens 106. The objective lens 106 converges the laser beam Lb and radiates a converged laser Lc to a processed object 107. The processed object 107 is placed on a stage 108 the movement of which can be controlled in an optical-axis direction (Z-axis) and in planes perpendicular to the optical axis (X, Y and θ directions).

After the light amount adjustment and waveform forming is performed to the laser beam Lb emitted from the laser beam source 101, the laser beam Lb is transmitted through a desired element in the plural transmission-type diffraction optical elements 108a, 108b, 108c and 108d installed on the surface of the rotation disc D, thereby irradiating the processed object 107 with the laser beam Lc having a desired laser beam profile and forming a desired process pattern in each case.

However, in the related-art laser processing apparatus and the processing method using the apparatus shown in Patent Document 1, one fine diffraction pattern is provided in one diffraction optical element as shown in FIG. 8B, therefore, it is necessary to select the diffraction optical element through which the laser beam La is transmitted from the plural diffraction optical elements 108a, 108b, 108c and 108d installed on the disc D and necessary to design and fabricate the diffraction optical element corresponding to each necessary laser beam profile to be set on the disc D when the laser beam profile is changed. Accordingly, enormous costs and time are necessary, which causes a problem of reduction of costs required for changing the laser beam profile.

### SUMMARY

In view of the above problems, as well as other concerns, a laser processing apparatus and a laser processing method according to various exemplary embodiments is capable of obtaining desired profiles suitable for processing by minimum required diffraction optical elements.

According to an embodiment, a laser processing apparatus includes a laser oscillator, a diffraction optical element made of a material through which a laser beam emitted from the laser oscillator is transmitted, in which at least two types of minute diffraction patterns are formed without a gap, capable of forming a profile of the laser beam, a movement unit moving any one of the laser beam and the diffraction optical element to change the relative position between the laser beam and the diffraction optical element, a control unit controlling operations of the movement unit, a scanning unit performing scanning with the laser beam transmitted through the diffraction optical element and a lens unit converging the laser beam used for scanning by the scanning unit on a laser irradiation surface of a processed object.

According to another embodiment, a laser processing apparatus includes a laser oscillator, a reflection-type diffraction optical element made of a material through which a laser beam emitted from the laser oscillator is transmitted, in which at least two types of minute diffraction patterns are formed without a gap, capable of forming a profile of the laser beam, a movement unit moving any one of the laser beam and the reflection-type diffraction optical element to change the relative position between the laser beam and the reflection-type diffraction optical element, a control unit controlling operations of the movement unit, a polarizer arranged at 45 degrees with respect to an optical axis between the laser oscillator and the reflection-type diffraction optical element and extracting a linearly polarized component of the laser beam emitted from the laser oscillator to form linearly polarized light, a ¼ wavelength plate arranged between the polarizer and the reflection-type diffraction optical element and changing the linearly polarized light incident from the polarizer to a circularly polarized light as well as changing the circularly polarized light incident from the reflection-type diffraction optical element to the linearly polarized light, a scanning unit performing scanning with a laser beam of the linearly polarized light which is the linear polarized light obtained from the ¼ wavelength plate being reflected by the polarizer and a lens unit converging the laser beam used for scanning by the scanning unit on a laser irradiation surface of a processed object.

According to further another embodiment, a laser processing method includes the steps of moving any one of a laser beam emitted from the laser oscillator and a diffraction optical element by a movement unit under the control by a control unit, changing the relative position between the laser beam and the diffraction optical element and radiating the laser beam to the diffraction optical element over at least two or more minute diffraction pattern areas provided in the diffraction optical element without a gap to allow the laser beam to be transmitted through the diffraction optical element, performing scanning with the laser beam transmitted through the diffraction optical element by using a scanning unit and converging the laser beam used for scanning by the scanning unit on a laser irradiation surface of a processed object by a lens unit.

According to another embodiment, a laser processing method includes the steps of extracting a linearly polarized component of a laser beam emitted from a laser oscillator by a polarizer arranged at 45 degrees with respect to an optical axis, changing a linearly polarized light of the laser beam incident from the polarizer to a circularly polarized light by a ¼ wavelength plate arranged between the polarizer and a reflection-type diffraction optical element, moving any one of the laser beam changed to the circularly polarized light and the reflection-type diffraction optical element by a movement unit under the control by a control unit, changing the relative position between the laser beam and the reflection-type diffraction optical element, radiating the laser beam to the reflection-type diffraction optical element over at least two or more minute diffraction pattern areas provided in the reflection-type diffraction optical element without a gap to allow the laser beam to be reflected on the reflection-type diffraction optical element, changing the circularly polarized light of the laser beam reflected on the reflection-type diffraction optical element and incident from the reflection-type diffraction optical element to the linearly polarized light by the ¼ wavelength plate and performing scanning with the laser beam reflected on the polarizer by using a scanning unit and converging the laser beam used for scanning by the scanning unit on a laser irradiation surface of a processed object by a lens unit.

As described above, it is possible to reduce the number of necessary diffraction optical elements and to adjust the beam profile intensity by relative relations between the laser beam and the diffraction optical element by applying the laser processing apparatus and the laser processing method according to the embodiments, therefore, desired profiles suitable for laser processing can be obtained inexpensively.

### BRIEF DESCRIPTION OF THE DRAWINGS

FIG. 1 is a schematic view showing a laser processing apparatus according to a first embodiment;

FIG. 2 is a view showing a diffraction optical element according to the first embodiment;

FIG. 3A is an explanatory view showing areas irradiated with a laser beam in the diffraction optical element and an example of a laser beam profile obtained in the vicinity of a focal point according to the first embodiment;

FIG. 3B is an explanatory view showing areas irradiated with a laser beam in the diffraction optical element and an example of a laser beam profile obtained in the vicinity of a focal point according to the first embodiment;

FIG. 3C is an explanatory view showing areas irradiated with a laser beam in the diffraction optical element and an example of a laser beam profile obtained in the vicinity of a focal point according to the first embodiment;

FIG. 3D is an explanatory view showing areas irradiated with a laser beam in the diffraction optical element and an example of a laser beam profile obtained in the vicinity of a focal point according to the first embodiment;

FIG. 4A is a view showing a laser processing method according to the first embodiment;

FIG. 4B is a view showing a laser processing method according to the first embodiment;

FIG. 4C is a view showing a laser processing method according to the first embodiment;

FIG. 5 is a view showing a diffraction optical element according to the first embodiment;

FIG. 6 is a view showing functions of the diffraction optical element according to the first embodiment;

FIG. 7 is a schematic view showing a laser processing apparatus according to a second embodiment;

FIG. 8A is a schematic view showing a related-art laser processing apparatus described in Patent Document 1; and

FIG. 8B is a schematic view showing four diffractive optical elements on a rotation disc in the related-art laser processing apparatus described in Patent Document 1.

### DESCRIPTION OF EMBODIMENTS

Hereinafter, various exemplary embodiments will be explained with reference to the drawings.

### First Embodiment

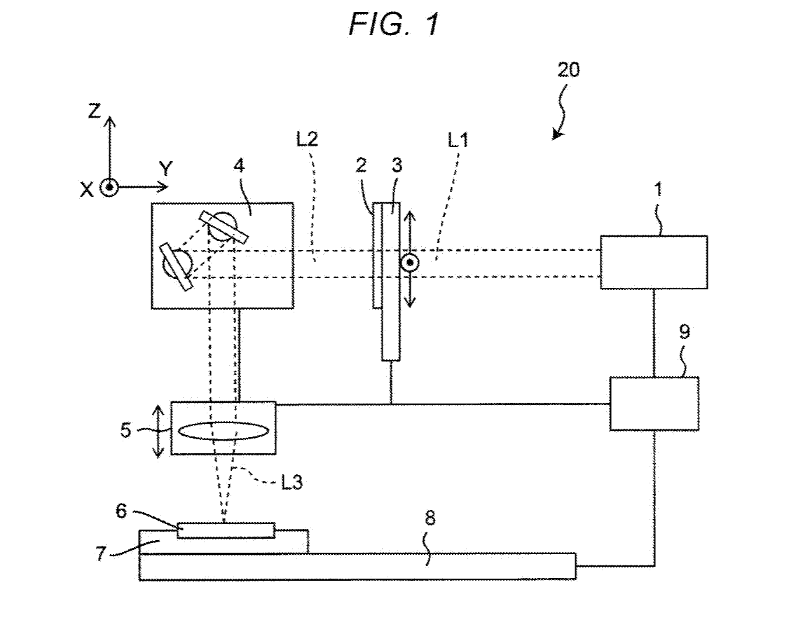

FIG. 1 is a schematic view showing a laser processing apparatus according to a first embodiment. In FIG. 1, a structure of the laser processing apparatus 20 and a laser processing method using the laser processing apparatus 20 will be explained.

The laser processing apparatus 20 includes a laser oscillator 1, a diffraction optical element 2, a movement unit 3, a control unit 9, a scanning unit 4 and a lens unit 5.

The laser oscillator 1 has a function of collimating a laser beam thereinside, emitting a parallel laser beam L1 from an emitting opening. As an example of the laser oscillator 1, a single-mode fiber laser in which a wavelength is 1070 nm, the maximum output is 3 kW, a diameter of a converged beam spot can be made small due to continuous oscillation and good beam quality, and further, the depth of focus is deep is cited as example for explanation in the first embodiment. The laser beam L1 is the parallel laser beam emitted from the laser oscillator 1.

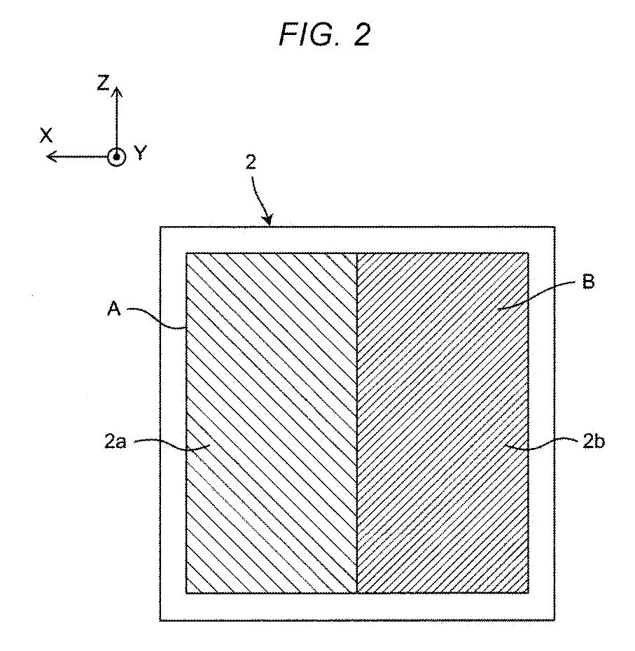

The diffraction optical element 2 is an optical element in which at least two types of fine diffraction patterns are formed without a gap and made of a material through which the laser beam L1 is transmitted, which can form a laser beam profile. FIG. 2 shows a schematic view of the diffraction optical element 2. The diffraction optical element 2 has at least two types of fine diffraction patterns 2a, 2b of an area A and an area B. For example, the diffraction optical element 2 has a square shape and respective areas have rectangular shapes of the same shape.

The movement unit 3 faces the minute diffraction patterns 2a, 2b of the diffraction optical element 2, which can fix and support the diffraction optical element 2 by providing an opening in a laser transmission part of the movement unit 3. The diffraction optical element 2 can move in the X-axis and Y-axis directions with respect to the laser beam L1 by the movement unit 3, which can change the relative position of the diffraction optical element 2 and the laser beam L1. A laser beam L2 is a laser transmitted through one or both of the fine diffraction patterns 2a, 2b of the diffraction optical element 2. Though the diffraction optical element 2 is moved with respect to the laser beam by the movement unit 3 in the first embodiment, it is also possible to fix the diffraction optical element 2 and to move the laser beam side with respect to the fixed diffraction optical element 2 by the movement unit 3. The movement unit 3 can include a motor and gear, and can be a conventional mechanical or electrical device for moving the optical element 2.

The scanning unit 4 performs scanning with the laser beam L2 transmitted through the diffraction optical element 2, including a galvano-mirror for X-axis direction and a galvano-mirror for Y-axis direction for reflecting the laser beam L2 and for changing the direction inside the scanning unit 4, which can radiate the laser beam L2 in an arbitrary orbit.

The lens unit 5 converges the laser beam L2 on a laser irradiation surface of the processed object 6. That is, the lens unit 5 is a fθ lens which can focus the laser beam L2 the irradiation direction of which is controlled by the scanning unit 4 onto one plane. The lens unit 5 which has a focal length of 255 mm is used as an example in the first embodiment.

The processed object 6 is irradiated with a laser beam L3 converged by the lens unit 5.

A jig 7 has a function of fixing the processed object 6.

The jig 7 is fixed in an XY stage 8 which can move the jig 7 in XY directions.

The control unit 9 controls at least operations of the movement unit 3. The control unit 9 is preferably connected to the laser oscillator 1, the movement unit 3, the scanning unit 4, the lens unit 5 and the XY stage 8, which can control respective operations by synchronizing these operations. The control unit 9 can be configured by a processor operating instructions stored in an associated memory, a microcontroller, ASIC, etc.

Next, operations of the laser processing apparatus 20 in the first embodiment will be explained.

The laser oscillator 1, the movement unit 3, the scanning unit 4, the lens unit 5 and the XY stage 8 are controlled by the control unit 9. The movement of the laser beam L1 radiated from the laser oscillator 1 is controlled by the movement unit 3 so as to be transmitted through desired target positions of the areas A, B on the minute diffraction patters 2a, 2b provided on the diffraction optical element 2 to be the laser beam L2 to which a desired beam profile is given. At this time, the laser beam L1 is positioned on the minute diffraction pattern 2a or 2b, or positioned over at least two or more minute diffraction patterns 2a and 2b. The laser beam L2 is reflected by the scanning unit 4 at an angle in which the laser beam L2 is radiated to a target position of laser processing on the processed object 6. At this time, a position of the lens unit 5 in the Z-axis direction is controlled by the control unit 9 so that a focal point of the lens unit 5 corresponds to the surface of the processed object 6. The laser beam L2 emitted from the scanning unit 4 is transmitted through the lens unit 5, and the laser beam L3 converged by the lens unit 5 is radiated to the processed object 6. The processed object 6 is fixed on the XY stage 8 in advance by the jig 7. As the laser beam L3 having a desired laser beam profile is radiated to the processed object 6, desired processing, for example, welding of butted aluminum plates is performed. The XY stage 8 is used for moving the processed object 6 at the time of processing a portion other than a range which can be scanned by the scanning unit 4 or used for mounting the processed object 6 on the laser processing apparatus 20 before and after the processing.

Here, the profile of the laser beam L3 at the converged beam spot is characterized by the diffraction optical element 2. Accordingly, when the minute diffraction patterns 2a and 2b of the diffraction optical element 2 differ, the profile at the converged beam spot is also changed.

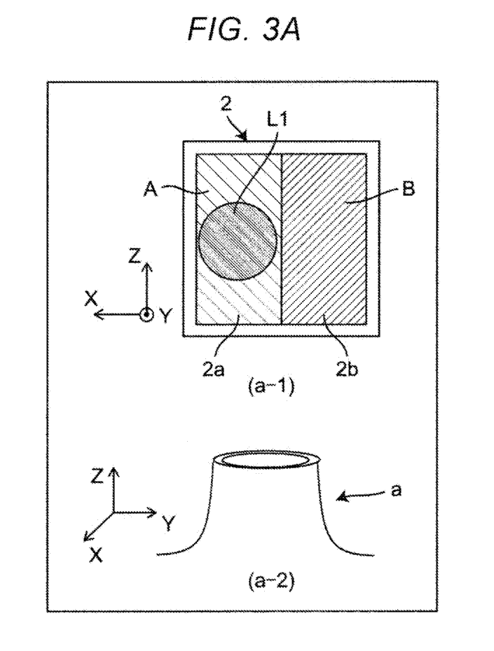

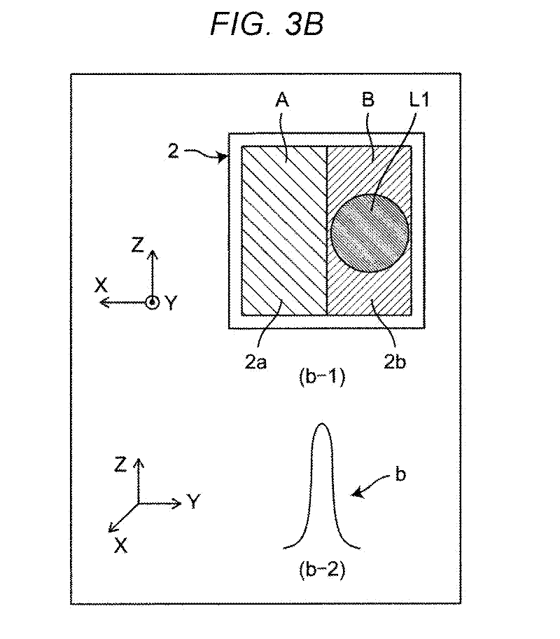

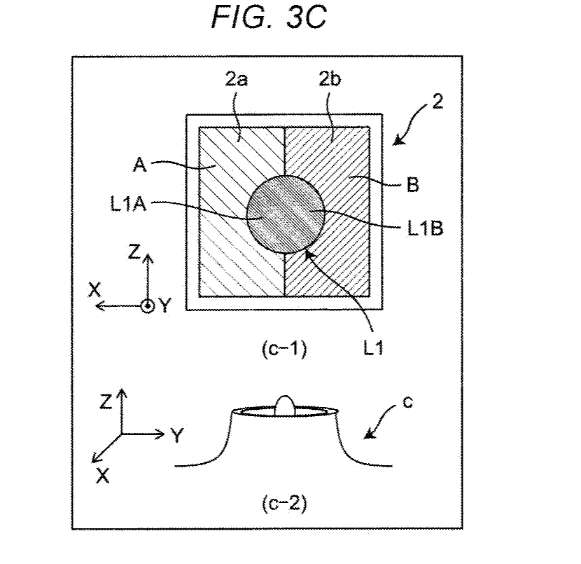

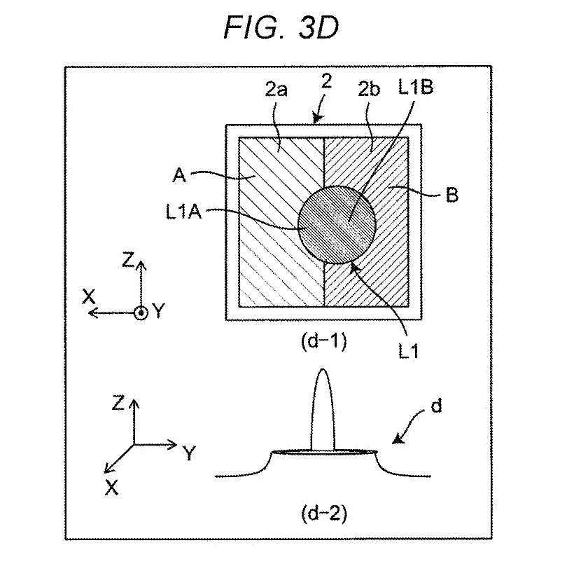

FIG. 3A to FIG. 3D show the areas A and B in which the laser beam L1 is radiated to the diffraction optical element 2 and profile examples of the laser beam L3 obtained in the vicinity of the focal point. An upper side drawing of FIG. 3A (a-1) shows a case where the laser beam L1 is radiated only to the minute diffraction pattern 2a in the area A, and a profile (profile “a”) shown in a lower side drawing of FIG. 3A (a-2) can be obtained. An upper side drawing of FIG. 3B (b-1) shows a case where the laser beam L1 is radiated only to the minute diffraction pattern 2b in the area B, and a profile (profile “b”) shown in a lower side drawing of FIG. 3B (b-2) can be obtained. Here, as shown in an upper side drawing of FIG. 3C (c-1), a profile (profile “c”) formed by adding the upper side drawing of FIG. 3A (a-1) to the upper side drawing of FIG. 3B (b-1) as shown in a lower-side drawing of FIG. 3C (c-2) can be obtained by uniformly radiating the laser beam L1 to the minute diffraction pattern 2a in the area A and the minute diffraction pattern 2b in the area B. At this time, a beam power of the profile “c” is equivalent to those of the profile “a” and the profile “b”, therefore, a peak power at a portion in the profile “c” corresponding to the profile “a” and the profile “b” is relatively reduced. When an area in which the laser beam L1 is radiated to the minute diffraction pattern 2a in the area A is defined as an area L1A and an area in which the laser beam L1 is radiated to the minute diffraction pattern 2b in the area B is defined as L1B, the diffraction optical element 2 is moved to a position where L1A<L1B as shown in an upper side drawing of FIG. 3D (d-1) by the movement unit 3 for obtaining another profile. A beam profile (profile “d”) in this case is indicated by a lower side drawing of FIG. 3D (d-2), which can change the intensity ratio between the profile “a” and the profile “b”.

The above will be explained by using butt welding of aluminum plates as an example.

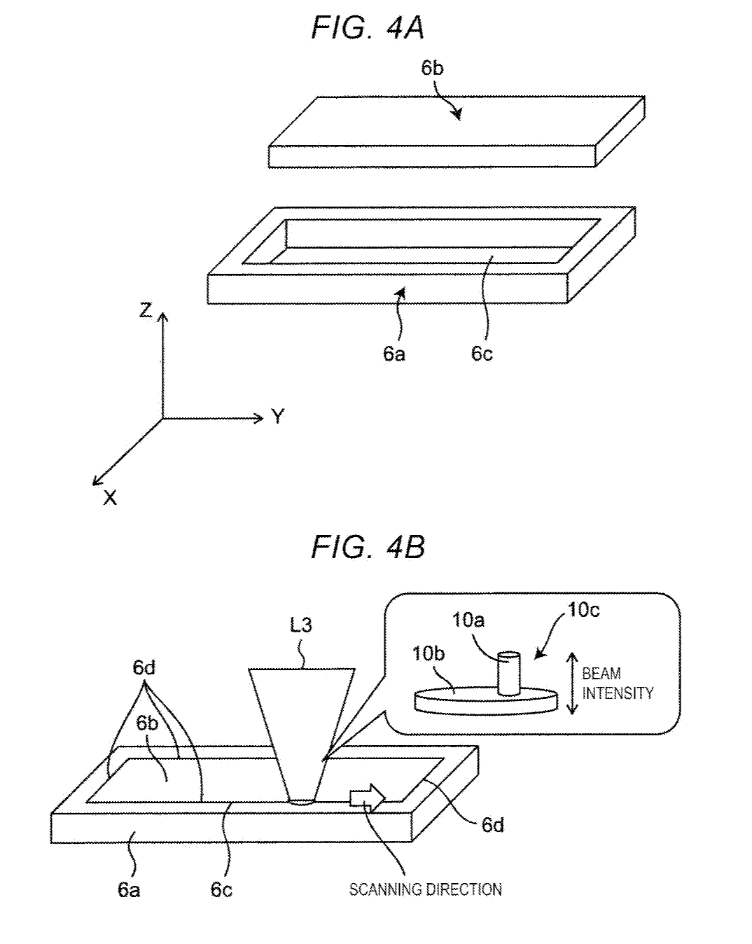

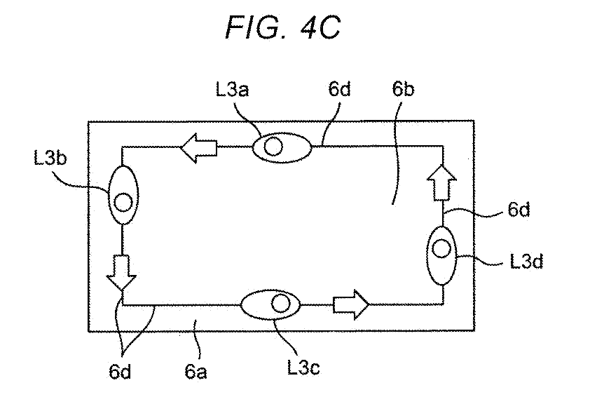

FIG. 4A shows processed objects 6a and 6b. The processed object 6a is a frame body and the processed object 6b is a lid body as examples. In the central part of the processed object 6a, there is a hole 6c having a shape to which the processed object 6b is fitted, and a gap between the processed objects 6a and 6b is sufficiently small with respect to a plate thickness in a state where the processed object 6b is set to the hole 6c of the processed object 6a, therefore, the welding can be performed without any problem. In this case, the processed object 6b is set to the hole 6c of the processed object 6a, the butted four sides 6d is irradiated with the laser beam L3 continuously around these sides, thereby welding the part of the sides 6d. An arrow in FIG. 4B indicates a scanning direction of the laser beam L3. As the laser beam profile used at the time of welding, a beam profile 10c in which a pre-heating and slow-cooling portion 10b is provided around a main beam 10a and the center of the main beam 10c is eccentric with respect to the center of the pre-heating and slow-cooling portion 10b as shown in FIG. 4B is used for suppressing welding defects such as spatters, voids and blowholes. In order to continuously scan the four sides 6d, it is necessary to prepare four types of profiles L3a, L3b, L3c and L3d in accordance with the scanning direction as shown in FIG. 4C.

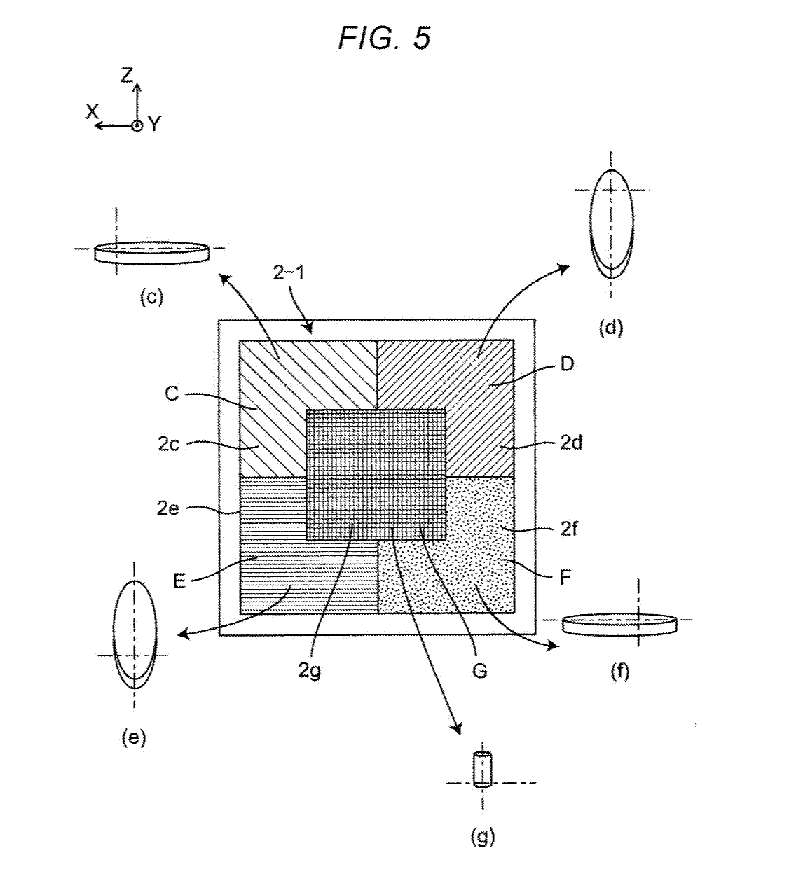

Here, a diffraction optical element 2-1 in which areas C, D, E, F and G of five fine diffraction patterns 2c, 2d, 2e, 2f and 2g are provided without a gap as shown in FIG. 5 is used. As an example, the diffraction optical element 2-1 has a square shape, in which respective areas C, D, E and F around the central area G is formed in the same L-shape, and only the central area G is formed in a regular square. For example, when the area C is irradiated with the laser beam L, a profile shown in (c) of FIG. 5 can be obtained. When the area D is irradiated with the laser beam, a profile shown in (d) of FIG. 5 can be obtained. When the area E is irradiated with the laser beam, a profile shown in (e) of FIG. 5 can be obtained. When the area F is irradiated with the laser beam, a profile shown in (f) of FIG. 5 can be obtained. When the area G is irradiated with the laser beam, a profile shown in (g) of FIG. 5 can be obtained. Accordingly, when some plural areas of the areas C, D, E, F and G are irradiated with the laser beam L1, the power of the profile to be obtained is determined in accordance with the irradiated area in proportion to the power distribution of the laser beam L1 transmitted through irradiated respective areas, and a laser beam shape in which profiles obtained by respective areas are combined can be obtained in the same manner as the case explained with reference to FIG. 3A to FIG. 3D.

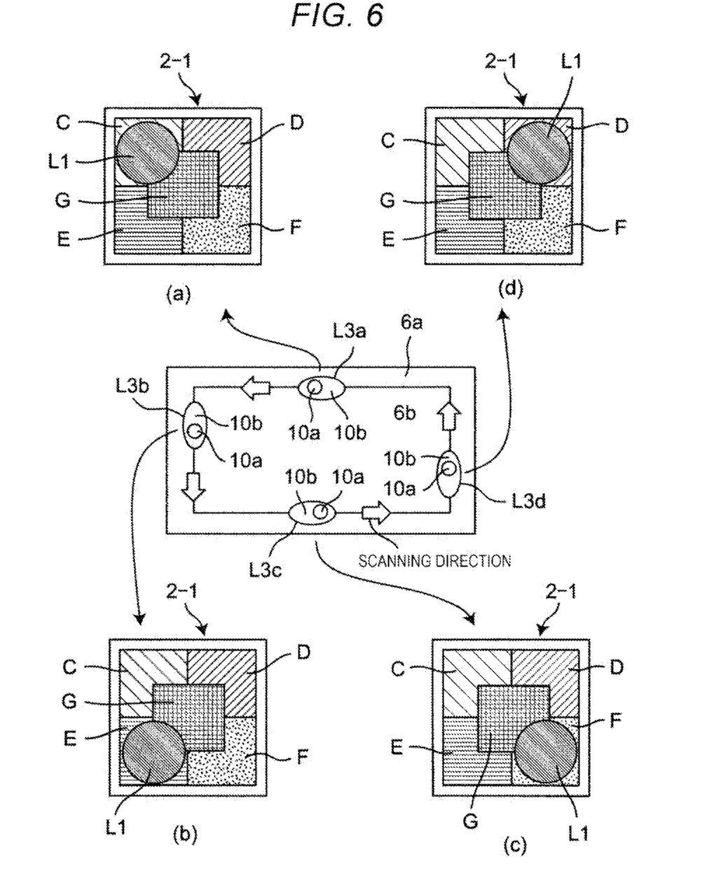

Profiles obtained in accordance with areas irradiated by the laser beam L in the diffraction optical element 2-1 are shown in FIG. 6. As shown in (a) to (d) of FIG. 6, the main beam 10a is obtained by irradiating the area G with the laser beam L1, and profiles of different directions of the pre-heating and slow-cooling portion 10b can be obtained by irradiating the areas C to F with the rest of the laser beam L1. Accordingly, when the scanning is performed with the laser beam L3 in the right direction on paper in FIG. 6 as shown in FIG. 4B, the diffraction optical element 2-1 is moved to a position where both the area F and the area G shown in (c) of FIG. 6 are irradiated with the laser light L1 by the movement unit 3 (FIG. 1). When the scanning is performed with laser beam L3 in an upward direction in FIG. 6, the diffraction optical element 2-1 is moved to a position where both the area D and the area G shown in (d) of FIG. 6 are irradiated. When the scanning is performed with the laser beam L3 in a left direction in FIG. 6, the diffraction optical element 2-1 is moved to a position where both the area C and the area G shown in (a) of FIG. 6 are irradiated. When the scanning is performed with the laser beam L3 in a downward direction in FIG. 6, the diffraction optical element 2-1 is moved to a position where both the area E and the area G shown in (b) of FIG. 6 are irradiated. Accordingly, four types of profiles (a) to (d) can be realized by one diffraction optical element 2-1.

Therefore, the operations of the movement unit 3 can be controlled to change the profile during processing by moving the relative position between the laser beam and the diffraction optical element 2 while changing the position in accordance with a processing state by the control unit 9 in an actual welding site. Here, the processing state means, for example, which side is welded in the butted four sides 6d when the processed object 6b is set in the hole 6c of the processed object 6a. That is, four types of profiles L3a, L3b, L3c and L3d corresponding to respective scanning directions of the four sides 6d as shown in FIG. 4C are stored in an internal storage of the control unit 9. Then, the operation of the movement unit 3 is controlled by the control unit 9 in accordance with which side is welded to thereby form a suitable profile from the four types of profiles.

As another example, a state of gaps is observed from above by a camera at the time of welding respective sides, and for example, when a gap at a corner of the side becomes larger than a given threshold value by laser processing, the operation may be controlled to change a profile in which, for example, the main beam 10a has a larger diameter than that of the stored profile for that side. In this state, the processing state means a state of change at a place to be welded generated by the processing.

According to the above structure, it is possible to obtain plural profiles by the diffraction optical element 2 having the minimum required minute diffraction patterns 2a, 2b while the processed object 6 is continuously scanned and irradiated with the laser beam L3 by controlling the relative position between the diffraction optical element 2 provided with at least two minute diffraction patterns 2a, 2b and the laser beam L1 by using the movement unit 3. Accordingly, processing costs can be reduced while maintaining processing quality. In other words, as the number of necessary diffraction optical elements 2 can be reduced and the intensity of the beam profile can be adjusted in accordance with the relative position between the laser beam and the diffraction optical element 2, it is possible to obtain a desired profile suitable for laser processing inexpensively.

The fiber laser is used as the laser oscillator 1 in the first embodiment, however, the laser is not limited to this, and an Nd: a YAG laser, a CO₂ laser, a semiconductor laser, ultrashort pulse lasers (a picosecond laser, a femtosecond laser) and so on can be used in accordance with the type of processing such as welding, removal or cutting as well as materials such as metal, resin and brittle materials.

As the diffraction optical element 2, a binary phase grating, a multilevel phase grating or a continuous phase grating can be used. Although profiles having similar shapes are set in the areas C to F in the example, it is also preferable to set completely different profiles. The number of areas can be determined to be suitable for processing as long as at least two or more areas are set.

The relative relation at the time of irradiating the diffraction optical element 2 with the laser beam L1 can be determined in accordance with the required laser beam profile. The diffraction optical element 2 may be positioned so that the laser beam L1 is radiated to one minute diffraction pattern or radiated at least over two or more minute diffraction patterns.

### Second Embodiment

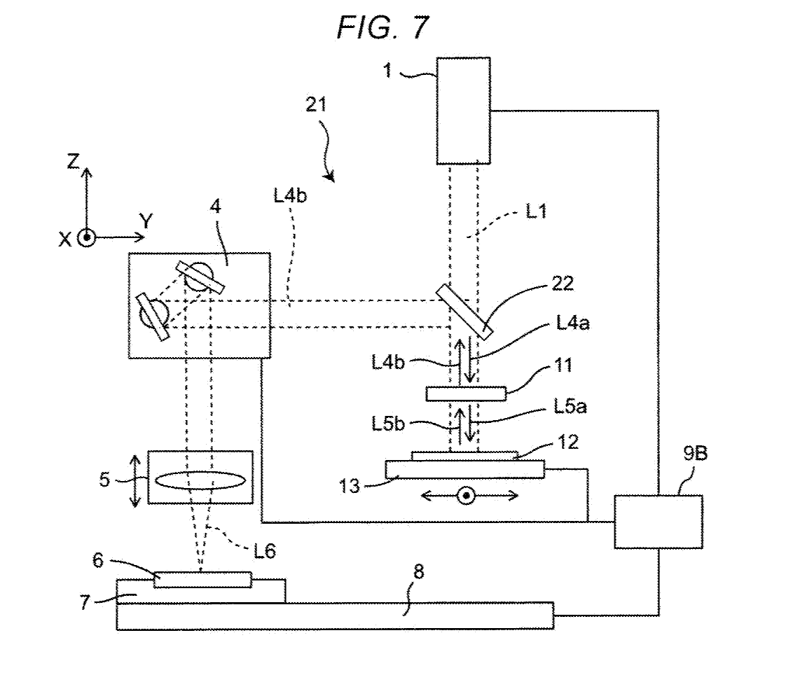

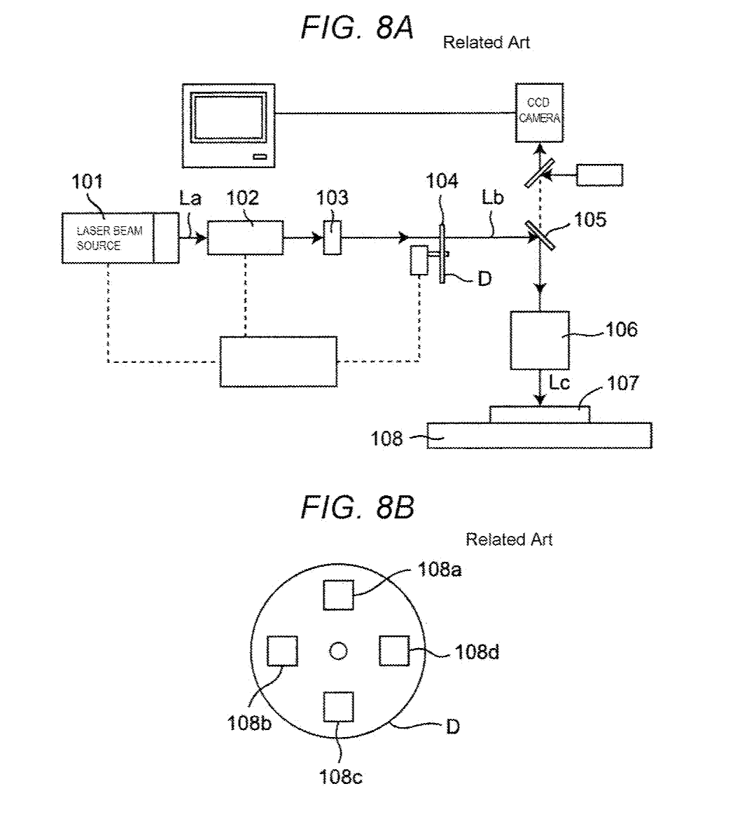

FIG. 7 is a schematic view of a laser processing apparatus 21 according to a second embodiment.

In FIG. 7, a structure of the laser processing apparatus 21 and a laser processing method using the laser processing apparatus 21 will be explained. Components having the same functions as those of the first embodiment are denoted by the same symbols and explanation thereof is omitted.

The laser processing apparatus 21 includes the laser oscillator 1, a polarizer 22, a ¼ wavelength plate 11, a reflection-type diffraction optical element 12, a movement unit 13, a control unit 9B, the scanning unit 4 and the lens unit 5.

The polarizer 22 is an optical element which can extract a linearly polarized component of the laser beam L1 from the laser oscillator 1 and reflect other components, which is installed at 45 degrees with respect to an optical axis. (A laser beam of) a linearly polarized light L4b incident on the polarizer 22 from the ¼ wavelength plate 11 is totally reflected by the polarizer 22 toward the scanning unit 4.

The ¼ wavelength plate 11 is an optical element having a function of giving a phase difference of π/2(=λ/4) in an electric-field oscillation direction (polarization plane) of the incident laser beam to thereby changing the linearly polarized light to a circularly polarized light and capable of changing the circularly polarized light to the linearly polarized light reversibly. Accordingly, the ¼ wavelength plate 11 gives the phase difference of π/2(=λ/4) in the electric-field oscillation direction (polarization plane) of the laser beam L1 which is incident after transmitted through the polarizer 22, thereby changing (a laser beam of) a linearly polarized light L4a to (a laser beam of) a circularly polarized light L5a. On the other hand, the ¼ wavelength plate 11 gives the phase difference of π/2(=λ/4) in the electric-field oscillation direction (polarization plane) of a laser beam incident from the reflection-type diffraction optical element 12, thereby changing (a laser beam of) a circularly polarized light L5b to (a laser beam of) a linearly polarized light L4b.

In the reflection-type diffraction optical element 12, at least two types of minute diffraction patterns (refer to, for example, two types of minute diffraction patterns 2a, 2b of FIG. 2) are formed without a gap. The reflection-type diffraction optical element 12 is formed of a material on which the laser beam L1 transmitted through the ¼ wavelength plate 11 is reflected, which can form a profile of the laser beam.

The movement unit 13 can fix the reflection-type diffraction optical element 12 and can move the reflection-type diffraction optical element 12 in X-axis and Y-axis directions with respect to the circularly polarized light L5a as well as can change the relative position between the reflection-type diffraction optical element 12 and the circularly polarized light L5a.

The control unit 9B controls at least operations of the movement unit 13. The control unit 9B is preferably connected to the laser oscillator 1, the movement unit 13, the scanning unit 4, the lens unit 5 and the XY stage 8, which can control respective operations by synchronizing these operations.

The scanning unit 4 performs scanning with the laser beam L4b reflected by the reflection-type diffraction optical element 12 as well as changed to the linearly polarized light, including a galvano-mirror for X-axis direction and a galvano-mirror for Y-axis direction for reflecting the laser beam L4b thereinside and for changing the direction, which can radiate the laser beam L4b in an arbitrary orbit.

Next, operations of the laser processing apparatus in the second embodiment will be explained. The laser oscillator 1, the movement unit 13, the scanning unit 4, the lens unit 5 and the XY stage 8 are controlled by the control unit 9B. The laser beam L1 radiated from the laser oscillator 1 by an instruction from the control unit 9B is transmitted through the polarizer 22 and receives the phase difference of π/2 in the electric-field oscillation direction to be the linearly polarized light L4a. The linearly polarized light L4a is transmitted through the ¼ wavelength plate 11 to be the circularly polarized light L5a, and is controlled by the movement unit 13 to be reflected on a target area on the minute pattern provided in the reflection-type diffraction optical element 12 to be the circularly polarized light L5b to which a desired beam profile is given. At this time, the circularly polarized light L5b is positioned on one minute diffraction pattern or positioned over at least two or more minute diffraction patterns. The circularly polarized light L5b is transmitted through the ¼ wavelength plate 11 again to receive the phase difference of π/2 in the electric-field oscillation direction, thereby obtaining the linearly polarized light L4b having a polarization direction 90 degrees different from the linearly polarized light L4a. The linearly polarized light L4b is not transmitted through the polarizer 22 and can be totally reflected on the polarizer 22. The linearly polarized light L4b reflected by the polarizer 22 is reflected at an angle in which the light is radiated to a target position on the processed object 6 by the scanning unit 4. At this time, the position in the lens unit 5 in the Z-axis direction is controlled by the control unit 9B so that a focal point of the lens unit 5 corresponds to the surface of the processed object 6. The laser beam L4b from the scanning unit 4 is transmitted through the lens unit 5, and a laser beam L6 converged by the lens unit 5 is radiated to the processed object 6. The processed object 6 is fixed on the XY stage 8 in advance by the jig 7. As the laser beam L6 having a desired laser beam profile is radiated to the processed object 6, desired processing, for example, a welding of butted aluminum plates is performed. The XY stage 8 is used for moving the processed object 6 at the time of processing a portion other than a range which can be scanned by the scanning unit 4 or used for mounting the processed object 6 on the laser processing apparatus 21 before and after the processing.

According to the above structure, it is possible to obtain plural profiles by the diffraction optical element 12 having the minimum required minute diffraction patterns by controlling the relative position between the reflection-type diffraction optical element 12 provided with at least two minute diffraction patterns and the circularly polarized light L5a by using the movement unit 13. Accordingly, processing costs can be reduced. In other words, as the number of necessary reflection-type diffraction optical elements 12 can be reduced and the intensity of the beam profile can be adjusted in accordance with the relative position between the laser beam and the reflection-type diffraction optical element 12, it is possible to obtain a desired profile suitable for laser processing inexpensively.

The fiber laser is used as the laser oscillator 1 in the second embodiment, however, the laser is not limited to this, and an Nd: a YAG laser, a CO₂ laser, a semiconductor laser, ultrashort pulse lasers (a picosecond laser, a femtosecond laser) and so on can be used in accordance with the type of processing such as welding, removal or cutting as well as materials such as metal, resin and brittle materials.

As the reflection-type diffraction optical element 12, a binary phase grating, a multilevel phase grating or a continuous phase grating can be used. The number of areas can be determined to be suitable for processing as long as at least two or more areas are set.

The relative relation at the time of irradiating the reflection-type diffraction optical element 12 with the circularly polarized light L5a can be determined in accordance with the required laser beam profile. The reflection-type diffraction optical element 12 may be positioned so that the circularly polarized light L5a is radiated to one minute diffraction pattern or radiated at least over two or more minute diffraction patterns.

Arbitrary embodiments and modification examples in the above various embodiments and modification examples are suitably combined, thereby obtaining advantages included in respective examples.

The laser processing apparatus and the laser processing method according to the various exemplary embodiments can reduce the number of necessary diffraction optical elements as well as adjust the beam profile intensity by the relative position between the laser beam and the diffraction optical element. Therefore, the various exemplary embodiments can be applied to processing applications for the laser processing apparatus and the laser processing method capable of obtaining desired profiles suitable for laser processing inexpensively.

What is claimed is:

1. A laser processing apparatus comprising:
a laser oscillator;
a diffraction optical element made of a material through which a laser beam emitted from the laser oscillator can be transmitted, the diffraction optical element including at least two types of minute diffraction patterns formed without a gap, capable of forming a profile of the laser beam;
a movement unit moving any one of the laser beam and the diffraction optical element to change a relative position between the laser beam and the diffraction optical element;
a control unit controlling operations of the movement unit;
a scanning unit performing scanning with the laser beam transmitted through the diffraction optical element; and
a lens unit converging the laser beam used for scanning by the scanning unit on a laser irradiation surface of a processed object.

2. The laser processing apparatus according to claim 1,
wherein the control unit controls the movement unit to adjust the relative position between the laser beam and the diffraction optical element so that the laser beam is radiated to positions over at least two or more types of minute diffraction patterns.

3. The laser processing apparatus according to claim 2,
wherein the control unit controls operations of the movement unit so as to change the profile during processing by moving the relative position between the laser beam and the diffraction optical element in accordance with a processing state.

4. A laser processing apparatus comprising:
a laser oscillator;
a reflection-type diffraction optical element made of a material through which a laser beam emitted from the laser oscillator can be transmitted, in which at least two types of minute diffraction patterns are formed without a gap, capable of forming a profile of the laser beam;
a movement unit moving any one of the laser beam and the reflection-type diffraction optical element to change the relative position between the laser beam and the reflection-type diffraction optical element;
a control unit controlling operations of the movement unit;
a polarizer arranged at 45 degrees with respect to an optical axis between the laser oscillator and the reflection-type diffraction optical element and extracting a linearly polarized component from the laser beam emitted from the laser oscillator to form linearly polarized light;
a ¼ wavelength plate arranged between the polarizer and the reflection-type diffraction optical element and changing the linearly polarized light incident from the polarizer to a circularly polarized light as well as changing the circularly polarized light incident from the reflection-type diffraction optical element to the linearly polarized light;
a scanning unit performing scanning with a laser beam of the linearly polarized light which is the linear polarized light obtained from the ¼ wavelength plate being reflected by the polarizer; and
a lens unit converging the laser beam used for scanning by the scanning unit on a laser irradiation surface of a processed object.

5. The laser processing apparatus according to claim 4,
wherein the control unit controls the movement unit to adjust the relative position between the laser beam and the reflection-type diffraction optical element so that the laser beam is radiated to positions over at least two or more types of minute diffraction patterns.

6. The laser processing apparatus according to claim 5,
wherein the control unit controls operations of the movement unit so as to change the profile during processing by moving the relative position between the laser beam and the reflection-type diffraction optical element in accordance with a processing state.

7. The laser processing apparatus according to claim 1,
wherein a fiber laser is used as the laser oscillator.

8. A laser processing method comprising:
moving any one of a laser beam emitted from a laser oscillator and a diffraction optical element by a movement unit under the control of a control unit, changing the relative position between the laser beam and the diffraction optical element and radiating the laser beam to the diffraction optical element over at least two or more minute diffraction pattern areas provided in the diffraction optical element without a gap to allow the laser beam to be transmitted through the diffraction optical element;
performing scanning with the laser beam transmitted through the diffraction optical element by using a scanning unit; and
converging the laser beam used for scanning by the scanning unit on a laser irradiation surface of a processed object by a lens unit.

9. The laser processing method according to claim 8,
wherein the relative position between the laser beam and at least two or more minute pattern areas provided in the diffraction optical element is changed in accordance with a scanning position of the laser beam.

10. A laser processing method comprising:
extracting a linearly polarized component of a laser beam emitted from a laser oscillator by a polarizer arranged at 45 degrees with respect to an optical axis, changing a linearly polarized light of the laser beam incident from the polarizer to a circularly polarized light by a ¼ wavelength plate arranged between the polarizer and the reflection-type diffraction optical element, moving any one of the laser beam changed to the circularly polarized light and the reflection-type diffraction optical element by a movement unit under the control by a control unit, changing the relative position between the laser beam and the reflection-type diffraction optical element, radiating the laser beam to the reflection-type diffraction optical element over at least two or more minute diffraction pattern areas provided in the reflection-type diffraction optical element without a gap to allow the laser beam to be reflected on the reflection-type diffraction optical element;
changing the circularly polarized light of the laser beam reflected on the reflection-type diffraction optical element and incident from the reflection-type diffraction optical element to the linearly polarized light by the ¼ wavelength plate and performing scanning with the laser beam reflected on the polarizer by using a scanning unit; and
converging the laser beam used for scanning by the scanning unit on a laser irradiation surface of a processed object by a lens unit.

11. The laser processing method according to claim 10,
wherein the relative position between the laser beam and at least two or more minute pattern areas provided in the reflection-type diffraction optical element is changed in accordance with a scanning position of the laser beam.

12. The laser processing method according to claim 8,
wherein the laser beam is emitted by a fiber laser as the laser oscillator.

13. The laser processing method according to claim 10,
wherein the laser beam is emitted by a fiber laser as the laser oscillator.
